(19) United States
(12) Patent Application Publication
(10) Pub. No.: US 2004/0015899 A1
(43) Pub. Date: Jan. 22, 2004

(54) Method for processing data

(76) Inventors: Frank May, Munchen (DE); Armin Nuckel, Neupotz (DE); Martin Vorbach, Munchen (DE); Markus Weinhardt, Munchen (DE); Joao Cardoso, Vila Nova de Paiva (PT)

Correspondence Address: KENYON & KENYON, ONE BROADWAY, NEW YORK, NY, 10004, US

(21) Appl. No.: 09/967,498

(22) Filed: Sep. 28, 2001

Related U.S. Application Data
(63) Continuation of application No. PCT/EP00/10516, filed on Oct. 9, 2000.
(60) Provisional application No. 60/238,855, filed on Oct. 6, 2000.

(30) Foreign Application Priority Data
Feb. 7, 2001 (EP) 01 102 674.7
Jun. 20, 2001 (DE) 101 29 237.6
Sep. 3, 2001 (DE) 101 42 894.4
Sep. 17, 2001 (DE) 101 45 795.2

(51) Int. Cl. G06F 9/45

(52) U.S. Cl. 717/140; 717/108

(57) ABSTRACT

The invention relates to a method for compiling programs on a system consisting of at least one first processor and a reconfigurable unit. It is provided in this method that the code parts suitable for the reconfigurable unit are determined and extracted and the remaining code is extracted in such a manner for processing by the first processor.

The present invention relates to conventional and reconfigurable architectures and to methods for these which allow the compilation of a traditional high-level language (PROGRAM) such as Pascal, C, C++, Java, etc., particularly to a reconfigurable architecture.

In the present text, a conventional processor architecture (PROCESSOR) is understood to be, for example, sequential processors with a von-Neumann or Havard architecture such as, e.g. controllers, CISC, RISC, VLIW, DSP and similar processors.

In the present text, a reconfigurable desired architecture is understood to be chips (VPU) with configurable function and/or networking, particularly integrated chips with a multiplicity of one- or multidimensionally arranged arithmetic and/or logic and/or analog and/or storing modules which are connected to one another directly or by means of a bus system.

The generic type of these chips includes, in particular, systolic arrays, neuron networks, multiprocessor systems, processors having a number of arithmetic logic units and/or logic cells and/or communicative/peripheral cells (IO), networking and network chips such as, e.g. crossbar switches and known chips of the generic FPGA, DPGA, Chameleon, XPUTER, etc. type. Particular reference is made in this context to the following patents and applications of the same applicant: P 44 16 881.0-53, DE 197 81 412.3, DE 197 81 483.2, DE 196 54 846.2-53, DE 196 54 593.5-53, DE 197 04 044.6-53, DE 198 80 129.7, DE 198 61 088.2-53, DE 199 80 312.9, DE 101 10 530.4, DE 101 11 014.6, PCT/EP 00/10516, EP O 102 674.7, PACT02, PACT04, PACT05, PACT08, PACT10, PACT11, PACT13, PACT21, PACT13, PACT18. These are herewith incorporated to their full extent for purposes of disclosure.

It has been found that there are certain methods and program sequences which can be processed better with a reconfigurable architecture than with a conventional processor architecture. Conversely, there are also those methods and program sequences which can be executed better by means of a conventional processor architecture.

The object of the present invention consists in providing new features for commercial applications.

The solution to this object is claimed in independent form.

It has been recognized that it is desirable for methods for data processing to be designed in such a manner that only the parts (VPU CODE) particularly suitable in each case for the reconfigurable target architecture (VPU) of the program to be compiled are extracted. These parts must be correspondingly partitioned and the configuration of the individual partitions must be controlled in the order in which they occur in time. The remaining parts of the program can then be compiled for a conventional processor architecture (PROCESSOR). This is preferably done in such a manner that these parts are output as high-level language code in a standard high-level language (e.g. ANSI C), in such a manner that a normal high-level language compiler (possibly one that already exists) can process them without problems.

It should also be noted that the methods can also be applied to groups of a number of chips.

An advantage of this method lies in the fact that existing code which has been written for an arbitrary PROCESSOR can still be used by including a VPU and only comparatively slight modifications need to be carried out. The modifications can be made step by step whereby more and more code can be gradually transferred from the PROCESSOR to the VPU. The project risk drops and the clarity is considerably enhanced. Furthermore, the programmer can operate in his usual development environment and does not need to adjust to a new development environment which may be strange.

### PRIOR ART

Known compilation methods for reconfigurable architectures do not support forwarding of code to arbitrary standard compilers for generating object code for an arbitrary PROCESSOR. The PROCESSOR is usually permanently defined within the compiler.

There are also no scheduling mechanisms for reconfiguration of the individual configurations generated for VPUs. In particular, there are no scheduling mechanisms for the configuration of independent extracted parts and nor are there for individual partition extracted parts, either.

Corresponding compilation methods of the prior art are defined, for example, by the dissertation “Übersetzungmethoden für strukturprogrammierbare Rechner [Compilation methods for structure-programmable computers], Dr. Markus Weinhardt, 1997, ISBN 3-89722-011-3”.

With respect to the partitioning of VPU CODE, a number of methods according to the prior art are known, e.g. João M. P. Cardoso, “Compilation of Java(™) Algorithms onto Reconfigurable Computing Systems with Exploitation of Operation-Level Parallelism”, Ph.D. Thesis, Universidade Técnica de Lisboa (UTL), Instituto Superior Técnico (IST), Lisbon, Portugal, October 2000.

However, these methods are not embedded in any complete compiler systems. Furthermore, the methods presuppose complete control of the reconfiguration by a host processor which means considerable expenditure. The partitioning strategies are designed for FPGA-based systems and, therefore, do not correspond to any real processor model.

System configuration

A PROCESSOR is joined to one or more VPU(s) in such a manner that an efficient exchange of information, particularly in the form of data and status information, is possible.

The arrangement of a conventional processor and of a reconfigurable processor in such a manner that data and status information can be exchanged between them during the processing of one or more programs and/or without the data processing on the reconfigurable processor and/or the conventional processor having to be interrupted to a significant degree, and the construction of such a system as far as can be seen from the text following, is also claimed.

For example, the following connecting methods and means are used:

a) Shared memory

b) Network (for example bus systems such as, e.g. PCI bus, serial buses such as, e.g. Ethernet)

c) Coupling to an internal register set or a number of internal register sets

d) Other storage media (hard disk, flash ROM, etc.).

The configuration of a VPU is known, for example, from PACT01, PACT02, PACT04, PACT05, PACT08, PACT10, PACT13, PACT17, PACT22, 24. Other alternative chip definitions are known, for example, by the name Chameleon.

VPUs can be integrated into a system in different ways. The connection to a host processor described is shown, for example, in PACT26US.

Depending on the method, the host processor can also take over control of the configuration (HOSTRECONF) (e.g. Chameleon) or a dedicated unit (CT) for controlling the (re)configuration can exist (PACT01, PACT04, PACT10, PACT17).

The compiler correspondingly generates the control information for the reconfiguration for a CT and/or a HOSTRECONF in accordance with the method described.

Principle of Compilation

From a PROGRAM, the parts which can be efficiently and/or usefully mapped for the VPU(s) determined in each case, are extracted by means of a PREPROCESSOR. These parts are output in a format suitable for VPUs (NML).

At the point where the code parts are missing due to the extraction, the remaining code and/or the extracted code is expanded by an interface code which controls the communication between PROCESSOR(s) and VPU(s) in accordance with the architecture of the target system. The remaining and possibly expanded code can be a) output in the form of a traditional high-level language (HOSTCODE), where the generic type of the code output can correspond, in particular, precisely to the generic type of the original high-level language.

b) compiled directly in object code for the PROCESSOR(s) in a compiler integrated in the preprocessor or connected directly to the preprocessor.

The high-level language which may have been extracted is compiled for the respective PROCESSOR(s) by means of a normal standard compiler and it is possible to build this in such a manner that no particular adaptation of the compiler to the data processing architecture used is necessary.

This method considerably simplifies the implementation effort of the programming environment. In addition, the user can still program and debug the PROCESSOR in the programming environment known to him, which he can freely select.

Compilation Sequence

Extraction

Firstly, the code (VPU CODE) appearing to be suitable for a VPU is extracted from the PROGRAM. The extraction can be based on different methods which are used individually or in combination. The following methods will be described in more detail by way of example.

Extraction by Annotation/Hints

The programmer explicitly provides instructions by means of annotations/hints within the PROGRAM as to which parts are to be extracted. For example, this can be done in the following way:

. . .
Code
# START_EXTRACTION
Code to be extracted
# END_EXTRACTION
. . .
Code
. . .
“// START_EXTRACTION” marks the beginning of a
code to be extracted.
“// END_EXTRACTION” marks the end of a code to be
extracted.

In such a case, the unit for converting the program into configuration codes is constructed for recognizing the hints or, respectively, conversion inputs.

Extraction by Calls of NML Routines

The programmer implements parts of the PROGRAM directly in NML and jumps into the NML routines by means of calls. For example, this is done in the following manner:

| | |
|---|---|
| a) | NML code |
| | . . . |
| | procedure EXAMPLE |
| | begin |
| | . . . |
| | end |
| | . . . |
| b) | PROGRAM code |
| | . . . |
| | Code |
| | . . . |
| | call EXAMPLE // Call of the NML code |
| | . . . |
| | Code |
| | . . . |

In this case, the unit for converting is constructed for including NML program parts, that is to say program parts for execution in and/or on a reconfigurable array, into a larger program.

Extraction from an Object-Oriented Class

Macros which are suitable for a VPU are defined as class in the class hierarchy of an object-oriented programming language. The macros can be identified by annotation in such a manner that they are detected as codes intended for a VPU and are correspondingly processed further—also in higher hierarchies of the language.

Within a macro, a certain networking and mapping by the macro is predetermined which then determines the mapping of the macro onto the VPU.

Instancing and concatenation of the class produces an implementation of the function consisting of a number of macros on the VPU. In other words, the instancing and concatenation of the macros defines the mapping and networking of the individual operations of all macros on the VPU.

The interface codes are added during the instancing. The concatenation describes the detailed mapping of the class onto the VPU.

A class can also be formed, for example, as a call of one or more NML routines.

| | |
|---|---|
| a) | Class code |
| | . . . |
| | class EXAMPLE |
| | begin |
| | . . . |
| | end |
| b) | PROGRAM code |
| | . . . |
| | Code |
| | . . . |
| | EXAMPLE via () // Instancing of the class |
| | . . . |
| | Code |
| | . . . |

Extraction by Analysis

Parts within the PROGRAM which can be efficiently and/or usefully mapped onto the VPU are detected by analysis methods adapted to the respective VPU. These parts are extracted from the PROGRAM.

One analysis method which, for example, is suitable for a large number of VPUs is the construction of data flow and/or control flow graphs from the PROGRAM. These graphs can be automatically searched with regard to their possible partitioning and/or mapping onto the target VPU. In this case, the parts of the graphs generated, or the corresponding PROGRAM PARTS, are extracted which can be sufficiently well partitioned and/or mapped. For this purpose, a partitionability and/or mappability analysis can be done which evaluates the respective characteristic.

Reference should be expressly made to the analysis methods described in patent application PACT11 which can be used, for example.

Compilation in NML

A compilation of the extracted code to NML, which is suitable for the implemented VPU, is performed.

For data-flow-oriented VPUs, for example, a data flow and/or control flow graph can be automatically constructed. The graphs are then compiled in NML code. Corresponding code parts such as, e.g. loops, can be compiled by means of a database (LookUp) or normal transformations can be performed. For code parts, macros can also be provided which are then used further in accordance with the IKR from PACT10.

The modularization according to PACT13, FIG. 28, can also be supported.

If necessary, the mapping to the VPU can be done already, for example by means of performing the placement of the resources needed and of the routing of the connections (place and route). This is done, for example, in accordance with typical known rules of placement and routing.

Analysis

The extracted code and/or the compiled NML code is analyzed for its processing efficiency by means of an automatic analysis method. The analysis method is preferably selected in such a manner that the interface code and the performance influences arising therefrom are included in the analysis at a suitable point. Suitable analysis methods are described, in particular, in PACT11.

If necessary, the analysis is performed by a complete compilation and implementation on the hardware system in that the PROGRAM is executed and surveyed with suitable methods as are known, for example, in accordance with the prior art.

Loop

Various parts selected for a VPU by the extraction can be identified as unsuitable on the basis of the analyses performed. Conversely, the analysis can show that certain parts extracted for a PROCESSOR would be suitable for execution on a VPU.

An optional loop which, after the analysis, on the basis of suitable decision criteria, leads back into the extraction part in order to execute it again with extraction inputs adapted in accordance with the analysis, makes it possible to optimize the compilation result. This thus provides an iteration.

The loop can be introduced into the compiler run at a number of different places.

Partitioning

If necessary, the NML code obtained must be partitioned, i.e. split into individual parts which can be mapped in each case into the existing resources, in accordance with the characteristics of the VPUs used. A multiplicity of such mechanisms, particularly those based on graph analysis, are known in accordance with the prior art. However, a preferred variant is based on the analysis of the program sources and is known by the term temporal partitioning. This method is described in said PHD Thesis by Cardoso which is incorporated to its full extent for purposes of disclosure.

Partitioning methods of whatever type must be adapted in accordance with the VPU type used. If there are VPUs according to PACT01, PACT04 which allow the storage of intermediate results in registers and/or memories, the partitioning must take into consideration the inclusion of the memories for storing data and/or states (compare PACT01, PACT04, PACT13, PACT11). The partitioning algorithms (e.g. the temporal partitioning) must be correspondingly adapted. Usually, however, the actual partitioning and the scheduling is considerably simplified, or even usefully made possible, by said patents.

According to PACT01, PACT10, PACT13, PACT17, PACT22, PACT24, some VPUs provide the possibility of differential reconfiguration. This can be used if only relatively few changes are necessary within the arrangement of PAEs during a reconfiguration. In other words, only the changes of a configuration with respect to the current configuration are reconfigured. In this case, the partitioning can be of such a type that the (differential) configuration following a configuration only contains the necessary reconfiguration data and does not represent a complete configuration.

Scheduling

The scheduling mechanisms for the partitioned codes can be expanded in such a manner that the scheduling is controlled by acknowledgements of the VPU to the reconfiguring unit in each case (CT and/or HOSTRECONF). In particular, the resultant possibility of conditional execution, i.e. of the explicit determination of the subsequent partition by the state of the current partition, is used during the partitioning. In other words, the partitioning must be optimized in such a manner that conditional executions such as, e.g. IF, CASE etc. are taken into consideration.

If VPUs are used which have the capability of transmitting status signals between the PAEs according to PACT08, PAEs responding to the states transmitted in each case, the conditional execution within the arrangement of PAEs that is to say without the necessity of complete or partial reconfiguration on the basis of an altered conditional program sequence can also be taken into consideration, within the partitioning and the scheduling.

Furthermore, the scheduling can support the possibility of preloading configurations during the run time of another configuration. In this process, a number of configurations can possibly also speculatively be preloaded, i.e. without being sure that the configurations are needed at all. The configurations to be used are then selected at run time by selection mechanisms according to PACT08 (see also Example NLS in PACT22/24).

Integration of the PROCESSOR and VPU Compilers

The code output is usually complete and can be executed without further interventions on the compilers which may follow in each case. If necessary, compiler flags and constraints are generated for the subsequent compilers and the user can optionally add their own inputs and/or modify the inputs generated. The subsequent compilers do not need any significant modifications so that standard tools can be used.

The method proposed is thus particularly suitable, for example, as a preprocessor preceding compilers and development systems.

Compiler According to PACT11

It should be expressly mentioned that, in principle, compilers according to PACT11 can also be included instead of the compiler described above.

Interface Code

The interface code used in the extracted code can be predetermined by different methods. The interface code is preferably stored in a database which is accessed. The unit for conversion can be constructed in such a manner that it takes into consideration a selection of the programmer who selects the appropriate interface code, for example using hints in the PROGRAM or using compiler flags. During this process, the interface code suitable for the implementation method used in each case can be selected.

The database itself can be built up and maintained by different methods. Some examples will be given to illustrate the possibilities:

a) The interface code can be predetermined by the supplier of the compiler for certain linking methods. This can be taken into consideration in the organization of the database by providing corresponding storage means for this information.

b) The interface code can be written by the user himself who has determined the system configuration or can be modified from existing (exemplary) interface code and added to the database. The database means is preferably made user-modifiable for this purpose in order to enable the user to modify the database.

c) The interface code can be automatically generated by a development system by means of which, for example, the system configuration has been planned and/or described and/or tested.

The interface code is usually designed in such a manner that it corresponds to the requirements of the programming language in which the extracted code is present into which code the interface code is to be inserted.

Debugging and Integration of the Tool Sets

Communication routines can be introduced into the interface codes in order to synchronize the different development systems for PROCESSOR and VPU. In particular, codes of the respective debugger (e.g. according to PACT21) can be accepted.

The interface code controls the exchange of data between PROCESSOR and VPU. It is, therefore, a suitable and preferred interface for controlling the respective development systems and debuggers. For example, it is possible to activate a debugger for the PROCESSOR for as long as the data are being processed by the processor. If the data are transferred to one (or more) VPUs via the interface code, a debugger for VPUs must be activated. If the code is sent back to the PROCESSOR, the PROCESSOR debugger should be activated, in turn.

It is, therefore, also possible and preferred to handle such sequences by inserting control codes for debuggers and/or development systems into the interface code.

The communication and control between different development systems should, therefore, be handled preferably by means of control codes inserted into the interface codes of PROCESSOR and/or VPU. The control codes can largely correspond to existing standards for controlling development systems.

The administration and communication of the development systems is preferably handled in the interface codes as described but can also be handled separately from these—if this is useful—in accordance with a corresponding similar method.

### DESCRIPTION OF THE FIGURES

FIG. 1 illustrates the proposed method and shows a possible system configuration. In this arrangement, a PROCESSOR (0101) is connected to a VPU (0103) via a suitable interface (0102) for exchanging data and status.

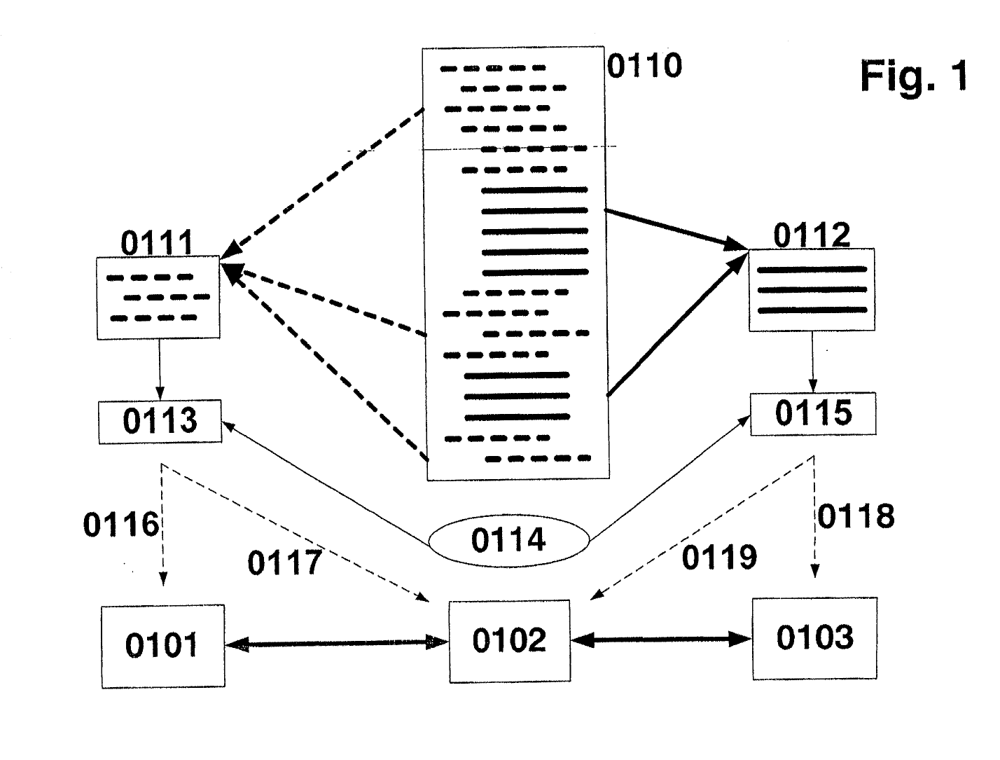

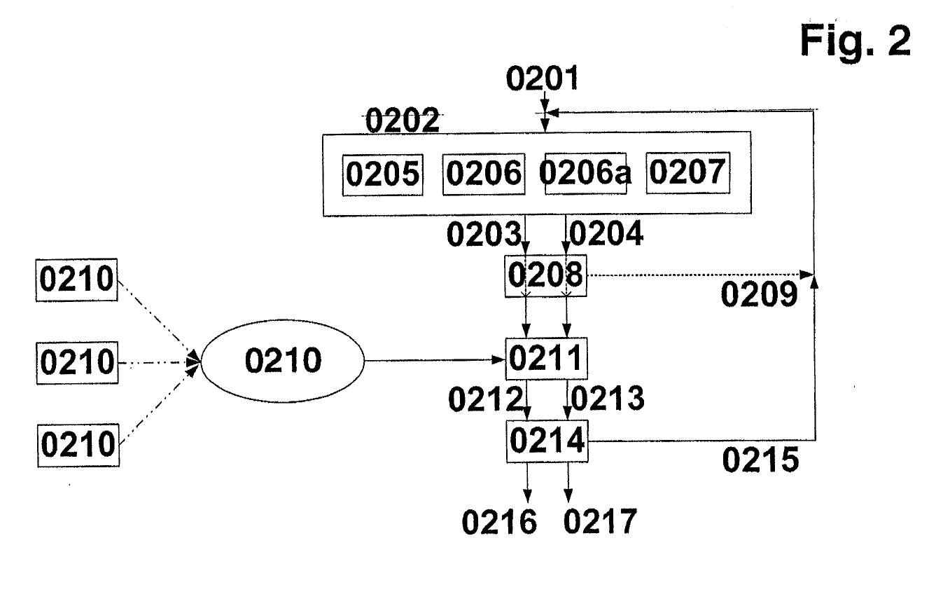

A PROGRAM code (0110) is split, for example in accordance with the extraction methods described, into a part (0111) suitable for the PROCESSOR and a part (0112) suitable for a VPU (for example by a preprocessor for a compiler).

0111 is compiled by a standard compiler (0113) (e.g. corresponding to the PROGRAM code), an additional code for describing and administering the interface (0102) between the PROCESSOR and a VPU being first inserted from a database (0114). Sequential code which can be executed on 0101 is generated (0116) and, if necessary, the corresponding programming (0117) of the interface (0102).

The standard compiler can be of such a type that it is present as a tool available on the market or in the context of a development environment customary on the market. The preprocessor and possibly the VPU compiler and possibly the debugger and other tools can be integrated for example, in the existing development customary available on the market.

0112 is compiled by a VPU compiler (0115), additional code for describing and administering the interface (0102) being inserted from a database (0114). Configurations which can be executed on 0103 are generated (0118) and, if necessary, the corresponding programming (0119) of the interface (0102).

Compiler According to PACT11

It should be mentioned expressly that, in principle, compilers according to PACT11 can also be used for 0115.

FIG. 2 shows by way of example a basic sequence of a compilation. A PROGRAM (0201) is split into VPU code (0203) and PROCESSOR code (0204) according to different methods in the extraction unit (0202). Different methods can be used for the extraction in arbitrary combination, for example annotations in the original PROGRAM (0205) and/or subroutine calls (0206) and/or analysis methods (0207) and/or utilization of object-oriented class libraries (0206a). The code extracted in each case is compiled if necessary and checked for its suitability for the respective target system (0208), if necessary. In this process, feedback (0209) to the extraction is possible in order to obtain improvements by altered allocation of the codes to the PROCESSOR or a VPU.

After that (0211), 0203 is expanded (0212) by the interface code from a database (0210) and/or 0204 is expanded by the interface code from 0210 to 0213.

The code produced is analyzed (0214) for its performance and if necessary, feedback to the extraction is possible in order to obtain improvements by an altered allocation of the codes to the PROCESSOR or a VPU.

The VPU code (0216) produced is forwarded to a subsequent compiler suitable for the VPU for further compilation. The PROCESSOR code (0217) produced is processed further in a suitable subsequent compiler suitable for the PROCESSOR for further compilation.

It should be noted that individual steps can be left out depending on the method. It is essential that largely complete code, which can be compiled directly without intervention by the programmer, is output to the respective downstream compiler systems.

The database for the interface codes (0210) is built up independently and before the compiler run. For example, the following sources are possible for the database: predetermined by the supplier (0220), user programmed (0221) or automatically generated by a development system (0222).

In summary, the present invention deals with methods which provide for a compilation of a traditional high-level language such as Pascal, C, C++, Java, etc. to a reconfigurable architecture. The method is designed in such a manner that only the parts of the program to be compiled which are in each case suitable for the reconfigurable target architecture are extracted. The remaining parts of the program are compiled to a conventional processor architecture.

1. A method for compiling programs to a system consisting of at least one first processor and a reconfigurable unit, wherein the code parts which are suitable for the reconfigurable unit are determined and extracted and the remaining code is extracted for processing by the first processor.

2. The method as claimed in claim 1, wherein interface code is added to the code extracted for the processor, in such a manner that communication between processor and reconfigurable unit is possible in accordance with the system.

3. The method as claimed in one of the preceding claims, wherein interface code is added to the code extracted for the reconfigurable unit, in such a manner that communication is possible between processor and reconfigurable unit in accordance with the system.

4. The method as claimed in one of the preceding claims, wherein the code to be extracted is determined on the basis of analyses.

5. The method as claimed in one of the preceding claims, wherein the code to be extracted is determined on the basis of annotations in the code.

6. The method as claimed in claim 1, wherein the code to be mapped onto the reconfigurable unit is defined by one or more class(es) of an object-orientated language.

7. The method as claimed in claim 1 and 6, wherein the mapping and networking of the individual operations of the code on the VPU is defined by the instancing and concatenation of the classes.

8. The method as claimed in one of the preceding claims, wherein the code to be extracted is determined on the basis of calls of subroutines.

9. The method as claimed in one of the preceding claims, wherein the interface code provides a shared memory.

10. The method as claimed in one of the preceding claims, wherein the interface code provides a shared register.

11. The method as claimed in claim 1, wherein the interface code provides coupling by means of a network.

12. The method as claimed in one of the preceding claims, wherein the extracted code is analyzed and, if necessary, the extraction is started again with new improved parameters.

13. The method as claimed in claim 1, wherein control code is added to the extracted code for administration and/or control and/or communication of the development systems.

14. The method as claimed in one of the preceding claims, wherein the first processor exhibits a conventional processor architecture, particularly a processor with von-Neumann and/or harvard architecture, controller, CISC, RISC, VLIW, DSP processor.

15. The method, particularly as claimed in one of the preceding claims, for compiling programs on a system consisting of a processor and a reconfigurable unit, wherein the code parts which are suitable for the reconfigurable unit are extracted,
the remaining code is extracted in such a manner that it can be compiled by means of any normal unmodified compiler suitable for the processor.

16. A device for processing data by means of at least one conventional processor and at least one reconfigurable unit, wherein it exhibits means for exchanging information, particularly in the form of data and status information between conventional processor and reconfigurable unit, the means being constructed in such a manner that an exchange of data and status information between them is possible during the processing of one or more programs and/or without the data processing, in particular, on the reconfigurable processor and/or the conventional processor having to be significantly interrupted.
